(19) United States
(12) Patent Application Publication
(10) Pub. No.: US 2013/0045314 A1
(43) Pub. Date: Feb. 21, 2013

(54) LIQUID SUCRALOSE SWEETENER COMPOSITION

(71) Applicants: Pratima N. Shastri, Tamil Nadu (IN); P. Vasudevarao, Bangalore (IN)

(72) Inventors: Pratima N. Shastri, Tamil Nadu (IN); P. Vasudevarao, Bangalore (IN)

(21) Appl. No.: 13/392,265

(22) PCT Filed: Aug. 24, 2010
(86) PCT No.: PCT/IN2010/000558

§ 371 Date: May 29, 2012

(30) Foreign Application Priority Data
Aug. 25, 2009 (IN) 1954/MUM/2009
Oct. 9, 2009 (IN) 2350/MUM/2009

(51) Int. Cl. A23L 1/236; A23L 3/3454

(52) U.S. Cl. 426/330; 426/548; 426/495; 426/532; 426/424

(57) ABSTRACT

An un-sterilized liquid concentrate sweetener composition containing 3-35% sucralose, at least one stabilizing additive having a pH of about 2.5 to 7.5 in the presence of a solvent in the concentrate sweetener, and one or more of the following ingredients: (A) mixed buffer with acid component being first edible acid and base component being salt of second acid with dissociation constant different than first acid to cover a range of pH from 4 to 6.5, (B) polymer stabilizer or hydrocollide stabilizer, (C) at least one osmoticum added to saturate water available for microbial growth in the composition and thereby check microbial growth, the water being added as an ingredient or the moisture may enter as ambient in the composition in course of reuse, and the osmoticum being an ingredient soluble in water and generates osmotic pressure in solution, (D) a preservative and (E) an antibiotic.

### TECHNICAL FIELD

This invention relates to sweetener compositions containing a high intensity sweetener as an ingredient.

### BACKGROUND OF THE INVENTION

On account of the changing lifestyles and diet patterns, metabolic disorders, like diabetes, CVD (Cardiovascular diseases), obesity are on rise. Requirement for high intensity non caloric sweetener for dietetic purpose is well recognized. Out of several available options, sucralose has the advantages such as zero calories, storage and processing stability at elevated temperatures and wide pH range, and versatility.

Several forms in which it can be used include powders, tablets and liquid. Non uniform distribution/dissolution of powder/tablets may create localized sweet spots or sweetness gradient, which is undesirable. Handling sucralose in powder form involves problem of its dusty nature and solid crystalline sucralose is known to be sensitive to heat during storage and is known to get discolored. A liquid sucralose concentrate composition is considered as a better and more convenient form as a sweetener composition that can be added directly to a composition that is needed to be sweetened, depending on the requirement, either by addition in a bulk or through a dispenser in small portions. Such a composition should be protected from microbial spoilage that is usually achieved by keeping the pH to acidic side in presence of preservatives that act against microbes. The pH, however, can not be at too acidic side, as sucralose shall hydrolyze and get discolored leading to rejection of the composition. The job of keeping the pH in desired range is achieved by using buffers. The desired range of pH to be covered is pH 3-7 for many food items including the beverages desserts, bakery and confectionary items.

U.S. Pat. No. 5,384,311 has disclosed a liquid sucralose concentrate composition consisting essentially of sucralose, a preservative system is limited to and selected from the group consisting of potassium sorbate, sodium benzoate, potassium benzoate, methyl gallate, propyl gallate, ethylenediaminetetraacetate, methyl paraben, propyl paraben and mixtures thereof, a buffering system is also limited to and selected from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartarate, adipic acid and sodium adipate, adipic acid and potassium adipate, malic acid and sodium malate, malic acid and potassium malate, and sodium phosphate monobasic and sodium phosphate dibasic and a liquid wherein the pH of the composition is from about pH 4.0 to about pH 5.5.

United States Patent application 20080299277 (Chao et al) discloses a composition, comprising: a sweetener selected from the group consisting of sucralose and certain other sweeteners and a mixture thereof; a preservative; and an acid; wherein the composition does not include a pH buffer.

Chao et al further disclose a composition, consisting of: a sweetener selected from the group consisting of sucralose and certain other sweeteners or a mixture thereof; a preservative; an acid; and a solvent.

Chao et al still further disclose a composition, comprising: sucralose; a second sweetener selected from the group consisting of a Luo Han Guo extract, a polyol, and a mixture thereof; a preservative; and an acid.

Chao et al still further disclose a composition, comprising: a sweetener; a preservative; and succinic acid.

Chao et al still further disclose a composition, comprising: sucralose; a preservative selected from the group consisting of certain preservatives; first acid selected from a certain group of acids; and a second acid different from the first acid, the second acid being selected from the group consisting of citric acid, succinic acid, lactic acid, propionic acid, tartaric acid, tannic acid, phosphoric acid, adipic acid, malic acid, acetic acid, gluconic acid, ascorbic acid, and a mixture thereof.

WO/2008/100235 describes a sterile sucralose preparation. The sterility will be lost after the pack is opened, and will be exposed to atmosphere and it will not be safe to use such a composition for multiple uses in a multiple use dispenser.

WO/2008/057967 discloses a sweetener composition comprising at least one preservative, a rebaudiocide A composition and a polyol.

Besides, there are prior art compositions, described below, that contain sucralose, a preservative system and a buffer. However, they are not sweetener compositions but are either food products themselves, beverages or beverage concentrates. Some of the illustrations of uses that are not considered as a liquid sweetener use for the purpose of this specification includes the following: US20020102331 and U.S. Pat. No. 7,052,725 (Chang) discloses methods for making artificially sweetened calcium fortified beverages and beverage concentrates, containing high intensity sweeteners along with calcium salts, flavors etc. U.S. Pat. No. 5,310,570, U.S. Pat. No. 5,472,716 (Kwapong et al) disclose food with high titratable acidity effective to suppress hunger. The low calorie foodstuff contains an edible acid to provide a total titratable acidity of at least 100, acids salts to buffer a solution of the foodstuff to a pH of 2.0 to 6.0, sweetener and flavoring. US20090041911, US20090041897 (Gamay) disclosed a composition of transparent, concentrated liquid nutritional supplement and nutritional components in a concentrated form. The composition includes sweeteners, nutritional supplements, and flavors, colors, thickening agents, acidifying agents or combinations thereof in a shelf stable format. The composition also describes making a portable lightweight liquid nutritional supplement mix or nutritional supplement. Additionally, the composition includes providing clear and non-turbid liquid nutritional supplement upon dilution in dilution media. None of the compositions disclosed here are liquid sucralose concentrate compositions meant to be used as a sweetener composition for dispensing sweetness to other recipes. U.S. Pat. No. 5,380,541 (Betys et al) describes a combination of sucralose with other saccharides, to achieve synergistic effects in various foods. It does not describe a liquid sweetener preparation.

Objective of the invention was to prepare stable liquid sucralose composition/s with improved new methods and improved new ingredient combination/s than described in prior art.

Specifically, the objective was to prepare stable liquid sucralose compositions that do not contain following combinations of ingredients: (I) a preservative system selected from the group consisting of potassium sorbate, sodium benzoate, potassium benzoate, methyl gallate, propyl gallate, ethylenediaminetetraacetate, methyl paraben, propyl paraben and mixtures thereof, and (b) a buffering system selected from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartrate, adipic acid and sodium adipate, adipic acid and potassium adipate, malic acid and sodium malate, malic acid and potassium malate, and sodium phosphate monobasic and sodium phosphate dibasic, (II) only an acid without buffer, (III) a preservative, an acid, and a solvent, (d) a group of a second sweetener selected from the group consisting of a Luo Han Guo extract, a polyol, and a mixture thereof; a preservative; and an acid, (IV) a preservative; and succinic acid, (V) two acids and a mixture thereof, (VI) at least one preservative, a rebaudioside A composition and a polyol. The combination of ingredients described above in this paragraph from (I) to (VI) have so comprehensively covered various routes of making liquid concentrate sweetener composition of sucralose that hardly any scope was left for any new route. However, it is surprising that better routes and better products were available that gave properties to the liquid concentrate composition of sucralose that were not available with the prior art compositions.

### SUMMARY OF INVENTION

The invention discloses an un-sterilized composition of liquid sucralose concentrate sweetener that contains sucralose as major sweetening ingredient in an amount of from 3 to 35% by weight of the total composition; the said composition further comprising at least one stabilizing additive which in presence of the said solvent in the said concentrate sweetener had a pH of about 2.5 to 7.5; the said stabilizing additive not comprising any of the following combinations of preservatives or stabilizers or sweeteners: (I) a preservative system selected from the group consisting of potassium sorbate, sodium benzoate, potassium benzoate, methyl gallate, propyl gallate, ethylenediaminetetraacetate, methyl paraben, propyl paraben and mixtures thereof, and (b) a buffering system selected from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartrate, adipic acid and sodium adipate, adipic acid and potassium adipate, malic acid and sodium malate, malic acid and potassium malate, and sodium phosphate monobasic and sodium phosphate dibasic, (II) only an acid without buffer, (III) a preservative, an acid, and a solvent, (IV) a group of a second sweetener selected from the group consisting of a Luo Han Guo extract, a polyol, and a mixture thereof; a preservative; and an acid, (V) a preservative; and succinic acid, (VI) two acids and a mixture thereof, (V) at least one preservative, (VI) a rebaudioside A composition and a polyol.

A process of preparing an un-sterilized composition of liquid sucralose concentrate sweetener that contains sucralose as major solid ingredient of this invention comprises steps of: (A) heating a required quantity of purified water to about 40° C. or about 60 degrees, (B) adding required quantity of sucralose with stirring, cooling to about 40 degrees if heated up to 60 degrees, (C) optionally treating with activated charcoal followed by filtration, (D) maintaining the temperature at 40-55° C. during mixing, cooling and filtering through 80 mesh filter, (E) adding at least one stabilizing ingredient followed sequentially by other ingredient/s if any, (F) adjusting the pH, if necessary, (G) making to final volume by the said solvent.

The said stabilizing additive in composition of this invention comprises at least of one of the following groups: (A) a mixed buffer with acid component being a first edible acid and the base component being a salt of second acid with dissociation constant different than the first acid to cover a range of pH from 4 to 6.5, or (B) a polymer stabilizer or a hydrocollide stabilizer, or (C) at least one osmoticum added to saturate water available for microbial growth in the composition and thereby check microbial growth, the said water being added as an ingredient or the moisture that may enter from the ambient in the composition in course of reuse, and the said osmoticum being an ingredient that is soluble in water and generates an osmotic pressure in solution, or (D) a preservative in absence of a buffering system, the said buffering system selected from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartrate, adipic acid and sodium adipate, adipic acid and potassium adipate, malic acid and sodium malate, malic acid and potassium malate, and sodium phosphate monobasic and sodium phosphate dibasic, or (E) an antibiotic permitted in food, or (F) a combination thereof.

The said first acid for the said mixed buffer is selected from fumaric acid, succinic acid, lactic acid, glutamic acid, glycine, gluconic acid, acetic acid (including di acetic acid), adipic acid, aspartic acid, citric acid, gluconic acid (glucono delta lactone), glutamic acid, lactic acid, malic acid, phosphoric acids (ortho, di and poly phosphoric acid), succinic acid, tartaric acid or a mixture thereof; and the said base of second acid selected, after omitting the salt of the said first selected acid, from the group sodium bicarbonate, dibasic sodium phosphates, sodium polyphosphates, sodium potassium tartarate, and other such salts selected from following: ammonium acetate, calcium acetate, potassium acetate, sodium acetate, ammonium adipate, potassium adipate, sodium adipate, potassium aspartate (mono and dibasic), sodium aspartate (mono and dibasic), ammonium bicarbonate, calcium bicarbonate, magnesium bicarbonate, potassium bicarbonate, sodium bicarbonate, potassium citrate (mono, di and tribasic), sodium citrate (mono, di and tribasic), potassium fumarate (mono and di), sodium fumarate (mono and di), calcium gluconate, potassium gluconate, sodium gluconate, potassium glutamate (mono and di), sodium glutamate mono and di), ammonium lactate, calcium lactate, magnesium lactate, potassium lactate, sodium lactate, calcium malate (mono and di), potassium malate (mono and di), sodium malate (mono and di), ammonium salts of phosphoric acids (mono and di basic salts), calcium salts of phosphoric acids (mono and di basic salts), magnesium salts of phosphoric acids (mono and di basic salts), potassium salts of phosphoric acids (mono and di basic salts), sodium salts of phosphoric acids (mono and di basic salts), sodium succinate (mono and dibasic), potassium succinate (mono and dibasic), sodium tartarate (mono and di basic), potassium tartarate (mono and di basic), sodium potassium tartarate, sodium aluminium phosphate (acidic), sodium aluminium phosphate (basic), or a combinations thereof.

The said polymer stabilizer may comprise, without limitations, Pectin, Sodium alginate, xanthan gum, or modified starch, or a combination thereof.

The said osmoticum may comprise, without limitation, any one of Sodium chloride, Potassium chloride, glucose, sucrose, corn syrup and invert sugar, or a combination thereof.

The said preservative may comprise, without limitation, any one of potassium sorbate, sodium benzoate, potassium benzoate, methyl gallate, propyl gallate, ethylenediaminetetraacetate, methyl paraben, propyl paraben, Acetic Acid, Sodium Acetate, Potassium Acetate, Sodium Diacetate, Potassium Diacetate, Sodium Metabisulphite, Potassium Metabisulphite, Calcium Hydrogen sulphite, Sodium Bisulphite, Potassium Bisulphite, Benzoic acid, Potassium Benzoate, Calcium Benzoate, Sodium Benzoate, Propionic acid, Potassium Propionate, Calcium Propionate, Sodium Propionate, Sorbic Acid, Potassium Sorbate, Calcium Sorbate, Sodium Sorbate, Ethylene Diamine Tetra Acetate, Calcium Ethylene Diamine Tetra Acetate, Sodium Ethylene Diamine Tetra Acetate, Ethyl Paraben, Methyl Paraben, SO₂, sodium metabysulphite or mixtures thereof.

The said antibiotic may be any food antibiotic including Nisin.

The said solvent used to make the liquid concentrate may include one or more of water, ethyl alcohol, polyethylene glycol, polysorbate, glycerol or a mixture thereof, may constitutes about 97% to 25% of the said composition and the pH may range between 2.5 to 7.5.

The buffering system may be present in an amount from 0.2% to 5% by weight of the total composition or more preferably in an amount from 0.5% to 2% by weight of the total composition.

In one specific embodiment of the sweetener composition of this invention, the sweetener of this invention comprises at least Sucralose, sodium benzoate, potassium sorbate, fumaric acid, sodium bicarbonate as ingredients dissolved in water. Preferably sucralose is present at 25%, sodium benzoate at 0.1%, potassium sorbate at 0.1%, fumaric acid at 0.232%, sodium bcarbonate at 0.237% and the composition is adjusted to pH 4.5.

### DETAILED DESCRIPTION OF INVENTION

Present invention discloses novel and improved stable liquid sucralose concentrate compositions containing 3 to 35%, preferably 15-30% sucralose, still more preferably 20 to 25% sucralose and an additive, wherein the composition does not conatin combination of (I) a preservative system selected from the group consisting of potassium sorbate, sodium benzoate, potassium benzoate, methyl gallate, propyl gallate, ethylenediaminetetraacetate, methyl paraben, propyl paraben and mixtures thereof, and (b) a buffering system selected from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartrate, adipic acid and sodium adipate, adipic acid and potassium adipate, malic acid and sodium malate, malic acid and potassium malate, and sodium phosphate monobasic and sodium phosphate dibasic, (II) only an acid without buffer, (III) a preservative, an acid, and a solvent, (IV) a group of a second sweetener selected from the group consisting of a Luo Han Guo extract, a polyol, and a mixture thereof; a preservative; and an acid, (V) a preservative; and succinic acid, (VI) two acids and a mixture thereof, or (VII) at least one preservative, a rebaudioside A composition and a polyol, or (VIII) Acesulfame k or aspartame as a sweetener ingredient.

The said additive in the composition of the invention is one or a combination of the following: (I) a mixed buffer with acid component being a first edible acid and the base component being a salt of second acid with dissociation constant different than the first acid to cover a range of pH from 4 to 6 (II) a polymer stabilizer or a hydrocollide stabilizer, (III) at least one osmoticum added to saturate water available for microbial growth in the composition and thereby check microbial growth, the said water being added as an ingredient or the moisture that may enter from the ambient in the composition in course of reuse, and the said osmoticum being an ingredient is soluble in water and generates an osmotic pressure in solution, (IV) a preservative in absence of a buffering system from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartrate, adipic acid and sodium adipate, adipic acid and potassium adipate, malic acid and sodium malate, malic acid and potassium malate, and sodium phosphate monobasic and sodium phosphate dibasic, (V) an antibiotic permitted in food, or (VI) a combination thereof.

A mixed buffer system enhances the stability over a wider pH range of 3.5-7.0.

Buffering agent adjusts the pH of a solution. The function of a buffering agent is to drive an acidic or basic solution to a certain pH state and prevent a change in this pH. These compounds are also called as pH managers and acid modulators. Acid modulators permitted in foods include various acids and salts.

A buffer solution is understood by a person of an ordinary skill in the art as an aqueous solution that consists of a mixture of a weak acid and its conjugate base or a mixture of a weak base and conjugate acid of the same. In presence of a buffer the pH of the solution shifts very little if a small amount of acid or base gets added to it. Characteristics of a buffer system are:
1. When pH=pKₐ, the buffer capacity of a weak acid is maximum.
2. When pH=pKₐ±1 the buffer capacity is 33% of the maximum value. This indicates the approximate range of efficacy of buffering by a weak acid. Incidentally, at pH=pKₐ−1, as per the Henderson-Hasselbalch equation, the ratio [HA]:[A⁻] is 10:1.
3. Analytical concentration of the acid and the buffer capacity are directly proportional.

In general a buffer solution is generally made up of more than one weak acid and its conjugate base. A wider buffer region is created by mixing the two buffering agents whose individual buffer regions overlap.

Combination of sunstances with pKₐ values differing by only two or less and adjustment of the pH creates a wide range of buffers which are usually termed as Universal Buffer Mixtures. Generally, Citric acid is used as one of the components of a buffer mixture because it has three pKₐ values, separated by less than two. Addition of other buffering agents would extend the buffer range of citric acid. One such example of two component mixture consisting of citric acid and dibasic sodium phosphate is McIlvaine's buffer solutions (www-saps.plantsci.cam.ac.uk/records/rec412.htm-9k) which has an effective buffer range of pH range of 3 to 8.

To achieve a pH range of 2.6 to 12 a mixture containing citric acid, potassium dihydrogen phosphate, boric acid, and diethyl barbituric acid can be made.

A compound or mixed buffer system suitable for application in food system comprises of an acid component combined with a buffer salt of another weak acid. The said acid may be a weak organic acid commonly used or useable in food, further comprising, as enlisted by Codex Alimentarius, Acetic acid (Including Di acetic Acid), Adipic acid, Aspartic Acid, Citric Acid, Fumaric acid, Gluconic Acid (Glucono Delta Lactone), Glutamic acid, Lactic Acid, Malic Acid, Phosphoric Acids (Ortho, Di and Poly Phosphoric Acid), Succinic Acid, Tartaric Acid, or a mixture thereof; and the said buffer salt of a weak acid may comprise a salt that is different from the selected acid, further comprising, as enlisted by Codex Alimentarius Ammonium Acetate, Calcium Acetate, Potassium Acetate, Sodium Acetate, Ammonium Adipate, Potassium Adipate, Sodium Adipate, Potassium Aspartate (Mono and Dibasic), Sodium Aspartate (Mono and Dibasic), Ammonium Bicarbonate, Calcium Bicarbonate, Magnesium Bicarbonate, Potassium Bicarbonate, Sodium Bicarbonate, Potassium Citrate (Mono, Di and Tribasic), Sodium Citrate (Mono, Di and Tribasic), Potassium Fumarate (Mono and Di), Sodium Fumarate (Mono and Di), Calcium Gluconate, Potassium Gluconate, Sodium Gluconate, Potassium Glutamate (Mono and Di), Sodium (Glutamate (Mono and Di), Ammonium Lactate, Calcium Lactate, Magnesium Lactate, Potassium Lactate, Sodium Lactate, Calcium Malate (Mono and Di), Potassium Malate (Mono and Di), Sodium Malate (Mono and Di), Ammonium Salts of Phosphoric Acids (Mono and Di basic salts), Calcium Salts of Phosphoric Acids (Mono and Di basic salts), Magnesium Salts of Phosphoric Acids (Mono and Di basic salts), Potassium Salts of Phosphoric Acids (Mono and Di basic salts), Sodium Salts of Phosphoric Acids (Mono and Di basic salts), Sodium Succinate (Mono and Dibasic), Potassium Succinate (Mono and Dibasic), Sodium Tartarate (Mono and Di basic), Potassium Tartarate (Mono and Di basic), Sodium Potassium Tartarate, Sodium Aluminium Phosphate (Acidic), Sodium Aluminium Phosphate (Basic), or a combinations thereof.

Sucralose is reported to have maximum stability within the pH range 4.5-6.0 (Lyn O'Brien “Alternative sweeteners” PP 191-201). Commonly used food acids have a pKa value between 4-5, and therefore, will not be effective up to pH 6.0 or more. Mixed buffers, particularly with sodium bicarbonate as part of the buffer system, are shown to be superior to single buffers. Thus, considering Fumaric acid:Na fumarate buffer pair, the ratio of fumaric acid:Na fumarate is in the range 1:5, to achieve desired pH of 4.5, whereas with Fumaric acid:NaHCO3, the ratio of acid to salt is near about 1:1, means total quantity of salt in formulation is reduced, and the effectiveness at pH>4.5 is enhanced. Carbonic acid released from sodium bicarbonate gives the flexibility to bicarbonate buffer between pH ranges 4-7, on account of CO2-HCO3 equilibrium. Further, dissolved CO2 liberated by bicarbonate at pH 4.5 will maintain slight anaerobiosis. Other ingredients used such as the preservative (e.g. Bisulphite, propionate, benzoate etc), stabilizer (e.g. pectin, Na salt of EDTA) osmotica (invert sugar) etc are likely to cause the deviation of pH. Classical buffer systems (citrate:citric acid, etc. claimed by Antenucci et al in U.S. Pat. No. 5,384,311) will be less effective in counteracting the pH shift due to these additives. Having a wider effective buffering range on account of mixed buffers also facilitates effect of preservatives at pH range 4.5-6.0.

Proposed concentrate can be an ingredient in various types of foods. The buffer components are selected to cover the possibility of
High acid foods (e.g. fruit jellies, pectin jelly, ready to serve (RTS) fruit beverages, synthetic and carbonated beverages)
Medium acid foods (eg. fruit based confections, yoghurt, shreekhand)
Low acid foods (fruit desserts, whey beverages, high protein beverages, malted milk foods)
Neutral foods (bakery products, ice-cream, tea, coffee, soya based products).

Incorporation of the concentrates with mixed buffer in such food items is expected to avoid sudden pH shift, which can bring about changes like protein precipitation or curdling.

The invention includes the use of a preservative or a mixture of preservatives that are not incompatible with each other or in the conditions of preservation or use, which are effective at the initial pH of the liquid sucralose preparation as well as at pH encountered in some foods, which may deviate from initial pH.

Metabisulphite preservative is especially effective against yeasts, which are acidophilic. It is a preservative of choice in low and medium acid liquid foods, with pH 3-5, such as fruit juices and pulp, squash and syrups.

Sodium or potassium metabisulphite plays a duel role. As preservative it leads to formation of dissolved SO2 in the liquid concentrate composition. It prevents the yeast growth. It also has antioxidant activity, which may be helpful in preventing discoloration. Propionate/benzoate/sorbate are more commonly used in medium or low acid foods, and especially intermediate moisture foods, where fungal deterioration is more common. Overall effectivity of the mixed preservative, with metabisulphite as one of the component, will be enhanced by the use of mixed buffer suggested in earlier statements.

Work done so far in liquid sucralose concentrate compositions has not disclosed the use of a combination of metabisulphite and propionate/benzoate/sorbate to widen the spectrum of protection against microorganisms, which has been explored in this invention.

Nisin is also used in some formulations in this invention. This is the only antibiotic permitted in food and would be efficacious in conjunction with other anti-microbial agents.

The invention also includes the use of stabilizers/humectants to control moisture loss during the long term use of the dispenser, which may change the sweetness intensity. The humectants suggested are sorbitol, mannitol, fructo oligosaccharides, carboxy methyl cellulose, dextran, pectin, Poly vinyl pyrrolidine.

Present invention discloses the use of a mixed buffer system, with acid component being one of the edible acids including, but not limited to, fumaric acid, succinic acid, lactic acid, glutamic acid, glycine, gluconic acid, Acetic acid (Including Di acetic Acid), Adipic acid, Aspartic Acid, Citric Acid, Fumaric acid, Gluconic Acid (Glucono Delta Lactone) Glutamic acid, Lactic Acid, Malic Acid, Phosphoric Acids (Ortho, Di and Poly Phosphoric Acid), Succinic Acid, Tartaric Acid or a mixture hereof, as well as other edible acids, which have a dissociation constant on acidic side. The base component is a salt of acid with dissociation constant different than the selected acid, to cover a wider range of pH, examples of such salts are, as enlisted by Codex Alimentarius, Sodium bicarbonate, dibasic sodium phosphates, sodium polyphosphates, sodium potassium tartarate, and other such salts selected from following: Ammonium Acetate, Calcium Acetate, Potassium Acetate, Sodium Acetate, Ammonium Adipate, Potassium Adipate, Sodium Adipate, Potassium Aspartate (Mono and Dibasic), Sodium Aspartate (Mono and Dibasic), Ammonium Bicarbonate, Calcium Bicarbonate, Magnesium Bicarbonate, Potassium Bicarbonate, Sodium Bicarbonate, Potassium Citrate (Mono, Di and Tribasic), Sodium Citrate (Mono, Di and Tribasic), Potassium Fumarate (Mono and Di), Sodium Fumarate (Mono and Di), Calcium Gluconate, Potassium Gluconate, Sodium Gluconate, Potassium Glutamate (Mono and Di), Sodium (Glutamate (Mono and Di), Ammonium Lactate, Calcium Lactate, Magnesium Lactate, Potassium Lactate, Sodium Lactate, Calcium Malate (Mono and Di), Potassium Malate (Mono and Di), Sodium Malate (Mono and Di), Ammonium Salts of Phosphoric Acids (Mono and Di basic salts), Calcium Salts of Phosphoric Acids (Mono and Di basic salts), Magnesium Salts of Phosphoric Acids (Mono and Di basic salts), Potassium Salts of Phosphoric Acids (Mono and Di basic salts), Sodium Salts of Phosphoric Acids (Mono and Di basic salts), Sodium Succinate (Mono and Dibasic), Potassium Succinate (Mono and Dibasic), Sodium Tartarate (Mono and Di basic), Potassium Tartarate (Mono and Di basic), Sodium Potassium Tartarate, Sodium Aluminium Phosphate (Acidic), Sodium Aluminium Phosphate (Basic), or a combinations thereof.

The selected preservative is from the list of codex approved preservatives, with Na/K-Metabisulphite, being more effective in liquid medium at acidic pH. This can be used in combination with other preservatives that are effective at higher pH so as to enhance the preservative action at wider pH range encountered in food systems. Preservatives useful as an ingredient in this invention include, but are not limited to, Acetic Acid, Sodium Acetate, Potassium Acetate, Sodium Diacetate, Potassium Diacetate, Sodium Metabisulphite, Potassium Metabisulphite, Calcium Hydrogen sulphite, Sodium Bisulphite, Potassium Bisulphite, Benzoic acid, Potassium Benzoate, Calcium Benzoate, Sodium Benzoate, Propionic acid, Potassium Propionate, Calcium Propionate, Sodium Propionate, Sorbic Acid, Potassium Sorbate, Calcium Sorbate, Sodium Sorbate, Ethylene Diamine Tetra Acetate, Calcium Ethylene Diamine Tetra Acetate, Sodium Ethylene Diamine Tetra Acetate, Ethyl Paraben, Methyl Paraben, Nisin, SO₂.

Sucrose, corn syrup, invert sugar and sodium chloride have been used as osmotica, to reduce water activity and act as preservatives thereby. “Osmoticum” as understood here is a matter that in contact water dissolves and produces an osmotic pressure. These are, thus, food ingredients that act as microbiostatic agent at high concentrations as well and may be preferred to preservatives that are not food ingredients. As per established knowledge, sucrose and a combination of sucrose with invert sugar has a preservative activity when present at a concentration of a minimum of 45-50° Brix in combination with acidic environment and SO2, as employed in squash. Some of the osmotica, such as sucrose, do have calories associated with themselves. However, that does not raise any practical concern. Sucralose being 600 times sweet compared to sucrose, the portion of the liquid sucralose concentrate required for normal sweetness delivery in the combination of both ingredients will carry too little sucrose to contribute any appreciable quantity of calories to an individual consumer. Further, a small quantity of sucrose associated with sucralose is known to go a long way in imparting closer sugary taste to a sucralose sweetener composition than a composition.

Osmotica other than sucrose and salt may also be considered. Salt, preferably can be Sodium Chloride or Potassium Chloride.

Common salt (Sodium Chloride) is also useful as an osmoticum. Salts other than common salt, Potassium Chloride for example, that are safe for consumption in food can replace common salt partly or fully either individually or in combination.

Accelerated storage studies for 6 months and long term storage studies presently showing results up to 12 months. Tests carried out include turbidity, discoloration, crystallization, Sucralose content, pH, plate count, Yeast and Mold count, pathogens, coliform bacteria count and organoleptic evaluation in comparison with sucrose.

Above experiments describe non limiting embodiments of the invention. Any variation in process conditions and the ingredients that are obvious to a person of ordinary skill in the art are included in above invention.

Further, it is clear to person of an ordinary skill in the art that the high intensity sweetener in above invention need not be limited to Sucralose and any other high intensity sweetener comprising Aspartame, Acesulphame K, Saccharine, stevioside and mixtures thereof that are compatible with each other could fully or partly replace sucralose.

Further, when higher concentration of sucralose is desired than is achievable than in plain water or for any other purpose, one or more of alternative solvents can be added that include alcohol, polyethylene glycol, polysorbate and glycerol can be used as liquid media in partial or total replacement with any one of them or in a mixture thereof.

In general, standard methods of compounding of the liquid formulations can be used for preparation of compositions of this invention.

In a preferred process, required quantity of purified water is added to a container, preferably a glass container, and heated to about 40° C., and required quantity of sucralose is added with stirring. Thereafter, stabilizing additives are added. If they are more than one, they may be added sequentially, and pH is adjusted (if necessary) before the final quantity is made up. The temperature is maintained at 40-55° C.; during mixing. The resultant mixture is stirred, cooled and filtered through 80 mesh filter. Optionally, after dissolving sucralose in water at about 40 degrees Celsius, the same is treated with activated charcoal followed by filtration. The dissolving of sucralose can also be carried out at 60° C., followed by addition of other compounds after the solution is cooled to 40° C.

When a preservative system and a buffer is added as stabilizers, it is preferably added after dissolution of sucralose and after its complete dissolution. It is followed by the addition of desired acid component of a buffer system and a corresponding buffer salt or an alkali that will generate the desired mixed buffer salt in reaction with the acid. In some formulations the said alkali added is sodium bicarbonate which will also generate carbon dioxide resulting in anerobiosis. The resultant mixture is stirred at 45-50° C. till a clear solution is obtained. pH is adjusted, if necessary, preferably between 4.2-4.6 with said alkai or the said acid as appropriate. The final weight is made up with remaining quantity of purified water at room temperature so that the final percentage of Sucralose in final solution is about 25% w/w. The reaction mixture is cooled down to room temp. To the clear solution, is added 0.05% w/w of activated charcoal in final solution, stirred well for 10 mins & filtered through a filter such as sparkler filters. The dissolving of sucralose can also be carried out at 60° C., followed by addition of other compounds after the solution is cooled to 40° C.

Ingredients of the illustrative compositions are given in table 1. Many other compositions will become apparent to a person of an ordinary skill in the art.

Compositions of present invention can be categorized to contain, in addition to water or non-aqueous solvent, with or without other ingredients compatible with the first ingredient, wherein first ingredient comprises (A) a novel buffer not used in prior art for liquid sucralose concentrate sweetener composition, including a mixed buffer, or (B) sodium metabisulphite, or (C) a hydrocolloid stabilizer comprising Pectin, Sodium alginate, xanthan gum, modified starch, carboxy methyl cellulose, fructo oligosaccaride, or (D) at least one osmoticum, or (E) a preservative, or (E) an antibiotic permitted in food, (F) a combination of one or more of above categories. The compositions were kept for Accelerated stability study at 40° C. Relative Humidity 75.0% for 6 months & for longterm stability study at 25° C. Relative Humidity 60.0% for 1 year. While mixed buffers could be used to improve the buffering capacity wherever buffering capacity is critically required, it was an unexpected surprising observation that addition of buffer and preservative is not a must for stability with respect to microbiological count, discoloration as well as hydrolysis, although they can be optionally be added, if the compositions were based on categories (B) to (F) mentioned above. From beginning up to 12 months of storage stability experiments, barring few exceptions, where the cause in case of these exception can not be related lack of buffers and preservatives, no discoloration, no hydrolysis and no microbiological count above permissible was found in any of the above categories tested in as many as 121 combinations and the organoleptic taste agreed well with the sucrose standard.

Exceptions to above observations include:

A light yellow colour was seen right from beginning in composition numbers 31 and 32 that contained 30% or more sucrose, the yellow colour disappeared in about 6 months and the compositions looked slightly hazy. In other compositions (numbers 33 to 38) that contained less than 30% sucrose, the compositions were colorless throughout. In the yellow compositions, sucralose assay, microbiological tests and organoleptic tests did not show any adverse observation.

Recrystallization was seen in all combinations in which sucralose dissolved was more than 25%, for example composition numbers 41, 45, 46, 50, 50b, 51, 65 to 76. However, recrystallization seems to have involved too little of sucrlose because assay of sucralose in all these instances is close to 100% within limits of experimental error of the assay.

A hazy (composition numbers 29, 29b and 30, slight hazy (39, 40, 43, 44, 46b, 47 and 48) or very slight hazy (45, 46) appearance was noted right from beginning and remained so at least up to 12 months of storage. All these compositions except two contained a hydrocolloid or a polymer such as pectin, fructo-oligosaccharide, Sodium alginate, Xanthan gum, modified starch, PVP. In composition 48, it was Sodium Potassium Tartrate and in composition 45 it was Calcium Propionate that could be responsible for hazymess. They cold all be related to adjusting a correct pH for their dissolution. Thus composition no. 14 contained Pectin with pH of 4.19 which remained clear in appearance. At other pH values above and below it, the compositions were slightly hazy.

Compositions 1 to 14, 16 to 30, 41 and 43 had acidic taste and odour. All of them had Sodium Metabisulphite in a concentration of either 2% or more. Rest of the compositions that had less than 2% sodium metabisulphite complied with the organoleptic evaluation with the sucrose taste.

All compositions in which sucralose dissolved was 25% or less, the compositions remained clear without any crystallization from beginning up to at least 12 months of storage.

It was a surprising observation that the pH remained practically stable right from beginning up to at least 12 months of storage in all composition whether they did or did not contain a buffer.

The Total Aerobic Microorganism Value (TAMV) and Yeast and Molds count (Y&M) was not more than maximum permissible value right from beginning up to at least the end of 12 months period of storage. Numerically it anged from less than 10 to less than 30 cfu.

Staphylococcus aureus, Salmonella, escherichia coli, Pseudomonas and coliform bacteria were absent through out from the beginning up to at least the end of 12 months period of storage.

Assay of sucralose was 100% on an average within the range of experimental error.

Composition number 78 produced on pilot scale production at least 5 times in particular and from 89-92 in general passed all the tested parameters.

### Example 1

### Analytical Methods

Sucralsoe Assay: Done as per USP-30 method of Sucralose Assay Analysis.

### Organoleptic Evaluation:

Samples were prepared of both standard sucralose solution and the test solutions from the formulations. The taste profile of the sample was compared against the standard. This was repeated by 3 other different people and a consensus is reached. Details of sample preparation are as follows.

### Sample Preparations:

Standard sample solution (S): Dissolve 0.0154 g of Standard Sucralose in 100 ml of mineral water.
Test Sample solutions: Prepare the samples as per the sucralose content in the formulation matching the standard sucralose concentration.

### Microbial Limits

The Total Aerobic Microorganism Value (TAMV), Yeast and Molds count (Y&M) and detection of Staphylococcus aureus, Salmonella, escherichia coli, Pseudomonas and coliform bacteria were done by (USP <62>).

### Preparation of Liquid Sucralose Concentrate

Following are illustrative compositions, and many of its variations and equivalents will become readily apparent to a person of an ordinary skill in the art.

Details of the some of the compositions that shall illustrate the compositions of this invention are given in Table 1. Many variations of these illustrative variations will be obvious and apparent to a person skilled in this art.

TABLE 1

| | | | | | | | | Long Term | | From |
|---|---|---|---|---|---|---|---|---|---|---|
| | | | | | | Accelerated | | stability | | Initial to |
| | | From Initial to 12 | | | | stability after 6 | | after 12 | | 12 months |
| | | months | | Initial | | months | | months | | Sensory |
| | Composition | Appearance | colour | Assay as Sucralose | pH | Assay as Sucralose | pH | Assay as Sucralose | pH | evaluation |
| Composition | Column number | | | | | | | | | |
| No. | 1 | 2 | 3 | 4 | 5 | 6 | 7 | 8 | 9 | 10 |
| 1 | Sucralose (25%), sodium metabisulphite (2.5%), | Clear liquid | Colourless | 24.97 | 4.25 | 24.92 | 4.2 | 24.78 | 4.21 | Not complies |
| | Fumaric acid (0.232%), Sodium bi carbonate (0.237%), | | | | | | | | | |
| | purified water (rest) pH 4.25 | | | | | | | | | |
| 2 | Sucralose(27.5%), sodium metabisulphite (2.5%), | Clear liquid | Colourless | 27.1 | 4.13 | 26.9 | 4.05 | 27.13 | 4.12 | Not complies |
| | Fumaric acid (0.232%), Sodium bi carbonate (0.237%), | | | | | | | | | |
| | purified water (rest) pH 4.13 | | | | | | | | | |
| 3 | Sucralose(30%), sodium metabisulphite (2.5%), Fumaric | Clear liquid, | Colourless | 29.02 | 4.28 | 28.9 | 4.17 | 28.97 | 4.15 | Not complies |
| | acid (0.232%), Sodium bi carbonate (0.237%), purified | Crystal formation | | | | | | | | |
| | water (rest) pH 4.28 | observed | | | | | | | | |
| 4 | Sucralose(25%), sodium metabisulphite (5.0%), Fumaric | Clear liquid | Colourless | 24.77 | 3.91 | 24.7 | 3.75 | 24.77 | 3.8 | Not complies |
| | acid (0.232%), Sodium bi carbonate (0.237%), purified | | | | | | | | | |
| | water (rest) pH 3.91 | | | | | | | | | |
| 5 | Sucralose(27.5%), sodium metabisulphite (5.0%), | Clear liquid, | Colourless | 27.3 | 3.96 | 27.2 | 3.8 | 27.25 | 3.8 | Not complies |
| | Fumaric acid (0.232%), Sodium bi carbonate (0.237%), | Crystal formation | | | | | | | | |
| | purified water (rest) pH 3.96 | observed | | | | | | | | |
| 6 | Sucralose(30%), sodium metabisulphite (5.0%), Fumaric | Clear liquid, | Colourless | 29.7 | 4.2 | 29.5 | 4.15 | 29.21 | 4.15 | Not complies |
| | acid (0.232%), Sodium bi carbonate (0.237%), purified | Crystal formation | | | | | | | | |
| | water (rest) pH 4.20 | observed | | | | | | | | |
| 7 | Sucralose(25%), sodium metabisulphite (7.5%), Fumaric | Clear liquid | Colourless | 25.12 | 4.1 | 25.05 | 4 | 24.92 | 3.9 | Not complies |
| | acid (0.232%), Sodium bi carbonate (0.237%), purified | | | | | | | | | |
| | water (rest) pH 4.10 | | | | | | | | | |
| 8 | Sucralose(27.5%), sodium metabisulphite (7.5%), | Clear liquid, | Colourless | 27.3 | 3.96 | 27.1 | 3.8 | 27.48 | 3.7 | Not complies |
| | Fumaric acid (0.232%), Sodium bi carbonate (0.237%), | Crystal formation | | | | | | | | |
| | purified water (rest) pH 3.96 | observed | | | | | | | | |
| 9 | Sucralose(30%), sodium metabisulphite (7.5%), Fumaric | Clear liquid, | Colourless | 29.4 | 4.1 | 29.3 | 4.0 | 29.14 | 3.76 | Not complies |
| | acid (0.232%), Sodium Fumarate (0.237%), purified | Crystal formation | | | | | | | | |
| | water (rest) pH 4.14 | observed | | | | | | | | |
| 11 | Sucralose (25.71), Sodium metabisulphite (4.0), Sodium | Clear liquid | Colourless | 25.7 | 4.39 | 25.5 | 4.2 | 25.32 | 4.1 | Not complies |
| | carboxyl methyl cellulose (0.2), Ascorbic acid (0.2), | | | | | | | | | |
| | Purified water (q.s.). pH 4.39 | | | | | | | | | |
| 12 | Sucralose (25.71), Sodium metabisulphite (4.0), | Clear liquid | Colourless | 25.4 | 4.53 | 25.2 | 4.1 | 25.07 | 4.0 | Not complies |
| | Maltodextrin (2.0), Ascorbic acid (0.28), Purified water | | | | | | | | | |
| | (q.s.). pH 4.53 | | | | | | | | | |
| 13 | Sucralose (25.71), Sodium Metabisulphite (4.0), Fructo | Clear liquid | Colourless | 25.62 | 4.45 | 25.6 | 4.3 | 25.66 | 4.2 | Not complies |
| | oligosaccharide (5.0), Ascorbic acid (0.12), Purified | | | | | | | | | |
| | water (q.s.). pH 4.45 | | | | | | | | | |
| 14 | Sucralose (25.71), Sodium metabisulphite (4.0), Pectin | Clear liquid | Colourless | 25.25 | 4.19 | 25.1 | 4.02 | 24.97 | 4.05 | Not complies |
| | (0.5), purified water (q.s.). pH 4.19 | | | | | | | | | |
| 15 | Sucralose(25%), sodium metabisulphite (2.5%), Fumaric | Clear liquid | Colourless | 24.93 | 4.2 | 24.9 | 4.1 | 25.02 | 4.02 | Complies |
| | acid (0.741%), Sodium fumarate (0.688%), purified | | | | | | | | | |
| | water (rest) pH 4.2 | | | | | | | | | |
| 16 | Sucralose(25%), sodium metabisulphite (5), Fumaric | Clear liquid | Colourless | 24.92 | 4.25 | 24.88 | 4.05 | 24.99 | 4.0 | Not complies |
| | acid (0.741%), Sodium fumarate (0.688%), purified | | | | | | | | | |
| | water (rest) pH 4.25 | | | | | | | | | |
| 17 | Sucralose(25%), sodium metabisulphite (7.5%), Fumaric | Clear liquid | Colourless | 24.93 | 4.3 | 24.9 | 4.25 | 25.03 | 4.2 | Not complies |
| | acid (0.741%), Sodium fumarate (0.688%), purified | | | | | | | | | |
| | water (rest) pH 4.30 | | | | | | | | | |
| 18 | Sucralose(27.5%), sodium metabisulphite (2.5%), | Clear liquid, | Colourless | 27.3 | 4.6 | 27.2 | 4.5 | 27.22 | 4.52 | Not complies |
| | Fumaric acid (0.150%), Sodium fumarate (0.731%), | Crystal formation | | | | | | | | |
| | purified water (rest) pH 4.60 | observed | | | | | | | | |
| 19 | Sucralose(27.5%), sodium metabisulphite (5%), Fumaric | Clear liquid, | Colourless | 27.5 | 4.53 | 27.3 | 4.5 | 27.3 | 4.49 | Not complies |
| | acid (0.150%), Sodium fumarate (0.548%), purified | Crystal formation | | | | | | | | |
| | water (rest) pH 4.53 | observed | | | | | | | | |
| 20 | Sucralose(27.5%), sodium metabisulphite (7.5%), | Clear liquid, | Colourless | 27.4 | 4.38 | 27.5 | 4.25 | 27.44 | 4.3 | Not complies |
| | Fumaric acid (0.150%), Sodium fumarate (0.640%), | Crystal formation | | | | | | | | |
| | purified water (rest) pH 4.38 | observed | | | | | | | | |
| 21 | Sucralose(30%), sodium metabisulphite (2.5%), Fumaric | Clear liquid, | Colourless | 29.45 | 4.48 | 29.5 | 4.4 | 29.33 | 4.35 | Not complies |
| | acid (0.150%), Sodium fumarate (0.640%), purified | Crystal formation | | | | | | | | |
| | water (rest) pH 4.48 | observed | | | | | | | | |
| 22 | Sucralose(30%), sodium metabisulphite (5%), Fumaric | Clear liquid, | Colourless | 29.2 | 4.52 | 29.1 | 4.38 | 29.51 | 4.33 | Not complies |
| | acid (0.150%), Sodium fumarate (0.8220%), purified | Crystal formation | | | | | | | | |
| | water (rest) pH 4.52 | observed | | | | | | | | |
| 23 | Sucralose(30%), sodium metabisulphite (7.5%), Fumaric | Clear liquid, | Colourless | 29.3 | 4.44 | 29.1 | 4.3 | 29.43 | 4.35 | Not complies |
| | acid (0.150%), Sodium fumarate (0.914%), purified | Crystal formation | | | | | | | | |
| | water (rest) pH 4.44 | observed | | | | | | | | |
| 24 | Sucralose(25%), sodium metabisulphite (2.5%), Fumaric | Clear liquid | Colourless | 24.93 | 4.49 | 24.84 | 4.4 | 24.67 | 4.4 | Not complies |
| | acid (0.150%), Sodium fumarate (0.640%), purified | | | | | | | | | |
| | water (rest) pH 4.49 | | | | | | | | | |
| 25 | Sucralose(25%), sodium metabisulphite (5%), Fumaric | Clear liquid | Colourless | 25.02 | 4.49 | 24.9 | 4.3 | 24.7 | 4.42 | Not complies |
| | acid (0.150%), Sodium fumarate (0.914%), purified | | | | | | | | | |
| | water (rest) pH 4.49 | | | | | | | | | |
| 26 | Sucralose(25%), sodium metabisulphite (7.5%), Fumaric | Clear liquid | Colourless | 24.8 | 4.44 | 24.7 | 4.35 | 24.79 | 4.41 | Not complies |
| | acid (0.150%), Sodium fumarate (0.548%), purified | | | | | | | | | |
| | water (rest) pH 4.44 | | | | | | | | | |
| 27 | Sucralose(27.5%), sodium metabisulphite (5%), Fumaric | Clear liquid, | Colourless | 27.6 | 4.5 | 27.1 | 4.4 | 27.02 | 4.5 | Not complies |
| | acid (0.050%), Sodium fumarate (2.285%), purified | Crystal formation | | | | | | | | |
| | water (rest) pH 4.50 | observed | | | | | | | | |
| 28 | Sucralose(27.5%), sodium metabisulphite (5%), Fumaric | Clear liquid | Colourless | 27.5 | 4 | 27.4 | 3.9 | 27.33 | 3.93 | Not complies |
| | acid (0.050%), Sodium fumarate (1.1%), purified water | | | | | | | | | |
| | (rest) pH 4.00 | | | | | | | | | |
| 29 | Sucralose (30.0), pectin (0.5), Sodium fumarate (2.377), | Clear liquid, | Slight hazy | 29.1 | 5.43 | 28.9 | 5.3 | 29.68 | 5.4 | Not complies |
| | purified water (q.s.), pH 5.43 | Crystal formation | | | | | | | | |
| | | observed | | | | | | | | |
| 29b | Sucralose (30.0), pectin (0.5), Sodium fumarate (3.4), | Clear liquid, | Slight hazy | 29.3 | 2.1 | 29.1 | 1.9 | 29.29 | 1.9 | Not complies |
| | purified water (q.s.), pH 2-3 | Crystal formation | | | | | | | | |
| | | observed | | | | | | | | |
| 30 | Sucralose (25.0), pectin (0.5), purified water (74.5), pH | Clear liquid | Slight hazy | 24.82 | 2.44 | 24.8 | 2.1 | 24.61 | 2.3 | Not complies |
| | 2.44 | | | | | | | | | |
| 31 | Sucralose (15.0), sucrose (50.0), purified water (35.0), | Clear liquid | Slight | 14.87 | 5.62 | 14.7 | 5.3 | 14.62 | 5.5 | Complies |
| | pH 5.62 | | Yellow | | | | | | | |
| 32 | Sucralose (25.0), sucrose 35.0), purified water (40.0), | Clear liquid | Slight | 24.5 | 5.86 | 24.3 | 5.4 | 24.66 | 5.7 | Complies |
| | pH 5.86 | | Yellow | | | | | | | |
| 33 | Sucralose (25.0), sodium chloride (5.0), sucrose (30.0), | Clear liquid | Colourless | 25.07 | 6.05 | 24.9 | 5.75 | 24.88 | 5.9 | Complies |
| | purified water (40.0), pH 6.05 | | | | | | | | | |
| 34 | Sucralose (25.0), sucrose (25.0), corn syrup (10.0), | Clear liquid | Colourless | 25 | 2.48 | 24.8 | 2.2 | 24.77 | 2.3 | Complies |
| | Fumaric acid (0.1), purified water (39.9). pH 2.48 | | | | | | | | | |
| 34b | Sucralose (25.0), sucrose (25.0), corn syrup (10.0), | Clear liquid | Colourless | 25.02 | 3.5 | 24.5 | 3.1 | 24.84 | 3.1 | Complies |
| | Fumaric acid (0.05), purified water (q.s.) pH 3.5 | | | | | | | | | |
| 35 | Sucralose (25.0), sodium chloride (15.0), glycine (0.2), | Clear liquid | Colourless | 25.1 | 6.53 | 24.8 | 6.2 | 24.72 | 6.3 | Complies |
| | purified water (q.s.) pH 6.53 | | | | | | | | | |
| 36 | Sucralose (25.0), sucrose 25.0), invert sugar | Clear liquid | Colourless | 25.02 | 2.15 | 25 | 2.02 | 24.83 | 2.1 | Complies |
| | (preservative) (10.0), purified water (q.s.), pH 2-2.2 | | | | | | | | | |
| 37 | Sucralose (22.5), sucrose (35.0), sodium metabisulphite | Clear liquid | Colourless | 21.9 | 4.33 | 21.9 | 4.27 | 21.88 | 4.2 | Complies |
| | (2.0), citric acid (0.525), purified water (q.s.) pH 4.33 | | | | | | | | | |
| 38 | Sucralose (25.0), sucrose 25.0), fumaric acid (0.15), | Clear liquid | Colourless | 24.8 | 2.59 | 24.7 | 2.2 | 24.5 | 2.2 | Complies |
| | ethanol (25.0), purified water (q.s.), pH 2.59 | | | | | | | | | |
| 39 | Sucralose (27.5), Sodium Metabisulphite (1.5), Fructo | Clear liquid, | Slight hazy | 27.72 | 4.31 | 27.7 | 4.25 | 27.13 | 4.2 | Complies |
| | oligosaccharide (10), fumaric acid (0.15), sodium | Crystal formation | | | | | | | | |
| | fumarate (0.5), Purified water (q.s.). pH 4.31. | observed | | | | | | | | |
| 40 | Sucralose (27.5), sodium potassium tartarate (2.0), PVP | Clear liquid, | Slight hazy | 27.5 | 7.18 | 27.4 | 6.7 | 27.25 | 6.9 | Complies |
| | (0.3), purified water (q.s.), pH 7.18. | Crystal formation | | | | | | | | |
| | | observed | | | | | | | | |
| 41 | Sucralose (27.5), sodium Metabisulphite (2.0), sodium | Clear liquid, | Colourless | 27.37 | 4.9 | 27.3 | 4.2 | 27.43 | 4.5 | Not complies |
| | potassium tartarate (0.2), PVP (0.3), purified water | Crystal formation | | | | | | | | |
| | (q.s.), pH 4.9. | observed | | | | | | | | |
| 42 | Sucralose (25.0), sodium alginate (0.1), sodium | Clear liquid | Colourless | 25.1 | 7.25 | 24.9 | 6.9 | 24.88 | 7.1 | Complies |
| | potassium tartarate (0.15), Purified water (q.s.), pH 7.25. | | | | | | | | | |
| 43 | Sucralose (27.5), Sodium Metabisulphite (2.0), Xanthan | Clear liquid, | Slight hazy | 27.8 | 4.02 | 27.6 | 3.8 | 27.66 | 3.8 | Not complies |
| | gum (0.2), fumaric acid (0.15), sodium fumarate (0.35), | Crystal formation | | | | | | | | |
| | Purified water (q.s.), pH 4.02. | observed | | | | | | | | |
| 44 | Sucralose (20.0), sucrose (25.0), Xanthan gum (0.2), | Clear liquid | Slight hazy | 19.9 | 4.07 | 19.8 | 4.1 | 19.86 | 3.9 | Complies |
| | fumaric acid (0.15), sodium fumarate (0.35), Purified | | | | | | | | | |
| | water (q.s.), pH 4.07. | | | | | | | | | |
| 45 | Sucralose (27.5), Ca-propionate (0.2), lactic acid (0.2), | Clear liquid, | very slight | 27.05 | 4.6 | 26.9 | 4.5 | 27.52 | 4.4 | Complies |
| | calcium lactate (0.25), purified water (q.s.), pH 4.6. | Crystal formation | hazy | | | | | | | |
| | | observed | | | | | | | | |
| 46 | Sucralose (27.5), sodium metabisulphite (1.0), lactic | Clear liquid, | very slight | 27.2 | 4.16 | 27.1 | 4.1 | 27.42 | 4.1 | Complies |
| | acid (0.1), calcium lactate (0.25), modified starch (1.0), | Crystal formation | hazy | | | | | | | |
| | purified water (q.s.), pH 4.16 | observed | | | | | | | | |
| 46b | Sucralose (27.5), modified starch (1.0), lactic acid (0.1), | Clear liquid, | Slight hazy | 27.6 | 4.16 | 27.5 | 4.2 | 27.48 | 4.02 | Complies |
| | calcium lactate (0.25), purified water (q.s.), pH 4.16. | Crystal formation | | | | | | | | |
| | | observed | | | | | | | | |
| 47 | Sucralose (25.0), Nisin (0.2), PVP (0.1), lactic acid (0.2), | Clear liquid | Slight hazy | 25.05 | 3.59 | 25.1 | 3.4 | 24.83 | 3.5 | Complies |
| | calcium lactate (0.25), Purified water (q.s.), pH 3.59 | | | | | | | | | |
| 48 | Sucralose (27.5), Nisin (0.2), lactic acid (0.15), calcium | Clear liquid, | Slight hazy | 27.4 | 3.68 | 27.3 | 3.2 | 27.25 | 3.55 | Complies |
| | lactate (0.25), Purified water (q.s.), pH 3.68 | Crystal formation | | | | | | | | |
| | | observed | | | | | | | | |
| 49 | Sucralose (25.0), Ca-propionate (0.25), xanthan gum | Clear liquid | Slight hazy | 25.01 | 6.18 | 24.8 | 5.8 | 24.93 | 6.02 | Complies |
| | (0.1), Purified water (q.s.), pH 6.18. | | | | | | | | | |
| 50 | Sucralose (27.5), Sodium Metabisulphite (0.1), Fumaric | Clear liquid, | Colourless | 27.2 | 4.38 | 27.1 | 4.33 | 27.28 | 4.3 | Complies |
| | acid (0.15), Sodium Fumarate (0.5), Sorbitol (10.0), | Crystal formation | | | | | | | | |
| | Purified Water (q.s.), pH 4.38 | observed | | | | | | | | |
| 50b | Sucralose (27.5), Sorbitol (10.0), fumaric acid (0.15), | Clear liquid, | Colourless | 27.8 | 4.38 | 27.4 | 4.3 | 27.45 | 4.25 | Complies |
| | sodium fumarate (0.5), Purified water (q.s.), pH 4.38. | Crystal formation | | | | | | | | |
| | | observed | | | | | | | | |
| 51 | Sucralose (27.5), mannitol (10.0), fumaric acid (0.15), | Clear liquid, | Colourless | 27.4 | 4.25 | 27.8 | 4.1 | 27.56 | 4.1 | Complies |
| | sodium fumarate (0.5), Purified water (q.s.), pH 4.25. | Crystal formation | | | | | | | | |
| | | observed | | | | | | | | |
| 52 | Sucralose (25.0), Sodium Metabisulphite (1.0), Glycine | Clear liquid | Colourless | 25.2 | 3.92 | 24.9 | 3.9 | 25.03 | 3.8 | Complies |
| | (0.1), Lactic Acid (0.06), Purified Water (q.s.), pH 3.92 | | | | | | | | | |
| 53 | Sucralose (25.0), Glycine (0.1), Lactic Acid (0.3), | Clear liquid | Colourless | 25.02 | 2.77 | 25.02 | 2.5 | 24.98 | 2.5 | Complies |
| | Purified Water (q.s.), pH 2.77 | | | | | | | | | |
| 54 | Sucralose (25.0), Glutamic acid (0.1), Sodium | Clear liquid | Colourless | 25.07 | 4.24 | 25.1 | 4.1 | 24.77 | 4.1 | Complies |
| | Metabisulphite (1.0), Sodium bicarbonate (0.028), | | | | | | | | | |
| | purified water (q.s.), pH 4.24 | | | | | | | | | |
| 55 | Sucralose (25.0), Glutamic acid (0.1), Sodium | Clear liquid | Colourless | 24.85 | 4.14 | 24.8 | 4.02 | 25.02 | 4.02 | Complies |
| | bicarbonate (0.035), purified water (q.s.), pH 4.14 | | | | | | | | | |
| 56 | Sucralose (25.0), Glycine (0.1), Lactic Acid (0.0028), | Clear liquid | Colourless | 25.0 | 4.2 | 24.9 | 4.15 | 25.01 | 4.1 | Complies |
| | Purified Water (q.s.), pH 4.20 | | | | | | | | | |
| 59 | Sucralose (25.0), Fumaric acid (0.1), Sodium | Clear liquid | Colourless | 25.12 | 4.56 | 24.8 | 4.5 | 25.23 | 4.4 | Complies |
| | Bicarbonate (0.237), Sodium Metabisulphite (0.15), | | | | | | | | | |
| | Purified Water (q.s.), pH 4.56 | | | | | | | | | |
| 60 | Sucralose (25.0), Fumaric acid (0.1), Sodium | Clear liquid | Colourless | 24.99 | 4.63 | 25.02 | 4.55 | 24.89 | 4.59 | Complies |
| | Bicarbonate (0.098), Sodium Metabisulphite (0.15), | | | | | | | | | |
| | Potassium Sorbate (0.1), Purified Water (q.s.), pH 4.63 | | | | | | | | | |
| 61 | Sucralose (25.0), Fumaric acid (0.2), Sodium | Clear liquid | Colourless | 25.4 | 4.44 | 25.5 | 4.4 | 25.25 | 4.3 | Complies |
| | Bicarbonate (0.09), Sodium Metabisulphite (0.15), | | | | | | | | | |
| | Sorbitol (10.0), Purified Water (q.s.), pH 4.44 | | | | | | | | | |
| 62 | Sucralose (25.0), Fumaric acid (0.2), Sodium | Clear liquid | Colourless | 25.03 | 4.48 | 24.9 | 4.38 | 25.01 | 4.35 | Complies |
| | Bicarbonate (0.15), Sodium Metabisulphite (0.15), | | | | | | | | | |
| | Calcium propionate (0.1), Mannitol (10.0), Purified | | | | | | | | | |
| | [symbol] | | | | | | | | | |
| 63 | Sucralose (25.0), Citric acid (0.1), Sodium Bicarbonate | Clear liquid | Colourless | 25.1 | 4.41 | 24.9 | 4.35 | 24.8 | 4.2 | Complies |
| | (0.15), Sodium Metabisulphite (0.15), Potassium | | | | | | | | | |
| | Sorbate (0.1), Purified Water (q.s.), pH 4.41 | | | | | | | | | |
| 64 | Sucralose (25.0), Citric acid (0.1), Sodium Bicarbonate | Clear liquid | Colourless | 25.5 | 4.45 | 25.2 | 4.31 | 24.7 | 4.33 | Complies |
| | (0.1), Sodium Metabisulphite (0.15), Potassium Sorbate | | | | | | | | | |
| | (0.1), Sorbitol (10.0), Purified Water (q.s.), pH 4.45 | | | | | | | | | |
| 65 | Sucralose (27.5), Gluconic acid (0.12), Sodium | Clear liquid, | Colourless | 27.6 | 4.4 | 27.7 | 4.3 | 27.6 | 4.25 | Complies |
| | Bicarbonate (0.1), Sodium Metabisulphite (0.15), | Crystal formation | | | | | | | | |
| | Potassium Sorbate (0.1), Purified Water (q.s.), pH 4.40 | observed | | | | | | | | |
| 66 | Sucralose (27.5), Sodium metabisulphite (0.15), | Clear liquid, | Colourless | 27.5 | 4.35 | 27.4 | 4.29 | 27.4 | 4.2 | Complies |
| | potassium Sorbate (0.1), gluconic acid (0.12), sodium | Crystal formation | | | | | | | | |
| | bicarbonate (0.1), Sorbitol (10.0), purified water (q.s.), | observed | | | | | | | | |
| | [symbol] | | | | | | | | | |
| 67 | Sucralose (27.5), Fumaric acid (0.2), Dipotassium | Clear liquid, | Colourless | 27.02 | 4.44 | 26.9 | 4.4 | 26.98 | 4.3 | Complies |
| | hydrogen phosphate (0.2), Sodium Metabisulphite (0.2), | Crystal formation | | | | | | | | |
| | Purified Water (q.s.), pH 4.44 | observed | | | | | | | | |
| 68 | Sucralose (27.5), Fumaric acid (0.1), Dipotassium | Clear liquid, | Colourless | 27.5 | 4.27 | 27.4 | 4.19 | 27.2 | 4.21 | Complies |
| | hydrogen phosphate (0.2), Sodium Metabisulphite (0.2), | Crystal formation | | | | | | | | |
| | Calcium propionate (0.1), Mannitol (10.0), Purified | observed | | | | | | | | |
| | [symbol] | | | | | | | | | |
| 70 | Sucralose (27.5), Fumaric acid (0.1), Sodium EDTA | Clear liquid, | Colourless | 27.62 | 4.44 | 27.5 | 4.28 | 27.44 | 4.38 | Complies |
| | (0.01), Sodium Metabisulphite (0.1), Sorbitol (10.0), | Crystal formation | | | | | | | | |
| | Purified Water (q.s.), pH 4.44 | observed | | | | | | | | |
| 71 | Sucralose (27.5), Fumaric acid (0.1), EDTA (0.01), | Clear liquid, | Colourless | 27.4 | 4.27 | 27.5 | 4.2 | 27.44 | 4.15 | Complies |
| | Dipotassium hydrogen phosphate (0.1), PVP (0.01), | Crystal formation | | | | | | | | |
| | Sodium Metabisulphite (0.5), Purified Water (q.s.), pH | observed | | | | | | | | |
| | [symbol] | | | | | | | | | |
| 72 | Sucralose (27.5), Fumaric acid (0.5), Sodium | Clear liquid, | Colourless | 26.9 | 4.47 | 26.8 | 4.35 | 26.92 | 4.33 | Complies |
| | Metabisulphite (0.5), Potassium Sorbate (0.01), Sorbitol | Crystal formation | | | | | | | | |
| | (10.0), Purified Water (10.0), pH 4.47 | observed | | | | | | | | |
| 73 | Sucralose (27.5), Sodium Metabisulphite (0.5), | Clear liquid, | Colourless | 27.2 | 5.2 | 27.1 | 5.1 | 27.1 | 5.01 | Complies |
| | Potassium Sorbate (0.01), Purified Water (q.s.), pH 5.20 | Crystal formation | | | | | | | | |
| | | observed | | | | | | | | |
| 74 | Sucralose (27.5), Fumaric acid (0.5), Dipotassium | Clear liquid, | Colourless | 27.6 | 4.34 | 27.5 | 4.32 | 25.18 | 4.3 | Complies |
| | hydrogen phosphate (0.1), Sodium Metabisulphite (0.1), | Crystal formation | | | | | | | | |
| | Potassium Sorbate (0.01), Mannitol (10.0), Purified | observed | | | | | | | | |
| | [symbol] | | | | | | | | | |
| 75 | Sucralose (27.5), Sodium Metabisulphite (0.1), | Clear liquid, | Colourless | 27.8 | 4.6 | 27.3 | 4.5 | 27.25 | 4.2 | Complies |
| | Potassium Sorbate (0.01), Purified Water (q.s.), pH 4.60 | Crystal formation | | | | | | | | |
| | | observed | | | | | | | | |
| 76 | Sucralose (27.5), Fumaric acid (0.1), Dipotassium | Clear liquid, | Colourless | 27.3 | 4.27 | 27.45 | 4.2 | 27.29 | 4.1 | Complies |
| | hydrogen phosphate (0.01), Sodium Metabisulphite | Crystal formation | | | | | | | | |
| | (0.1), Potassium Sorbate (0.1), Mannitol (10.0), Purified | observed | | | | | | | | |
| | [symbol] | | | | | | | | | |
| 77 | Sucralose (25.0), Fumaric acid (0.1), Dipotassium | Clear liquid | Colourless | 25.1 | 4.28 | 24.9 | 4.22 | 24.9 | 4.2 | Complies |
| | hydrogen phosphate (0.5), Sodium Metabisulphite (0.1), | | | | | | | | | |
| | Potassium Sorbate (0.15), Mannitol (10.0), Purified | | | | | | | | | |
| | [symbol] | | | | | | | | | |
| 78 | Sucralose (25%), Sodium Benzoate (0.1%), Potassium | Clear liquid | Colourless | 25.3 | 4.5 | 25.2 | 4.38 | 25.02 | 4.4 | Complies |
| | sorbate (0.1%), Fumaric acid (0.232%), Sodium | | | | | | | | | |
| | bicarbonate (0.237%), Purified water, pH 4.5 | | | | | | | | | |
| 79 | Sucralose(25%), Sodium Benzoate (0.1%), Potassium | Clear liquid | Colourless | 25.1 | 4.49 | 24.93 | 4.42 | 24.9 | 4.49 | Complies |
| | sorbate (0.1%), Fumaric acid (0.15%), sodium fumarate | | | | | | | | | |
| | (0.64%), Purified water, pH 4.49 | | | | | | | | | |
| 81 | Sucralose(25%), Sodium Benzoate (0.05%), Sodium | Clear liquid | Colourless | 25.2 | 4.3 | 25.2 | 4.25 | 24.8 | 4.2 | Complies |
| | metabisulfite (0.1%), Sodium bicarbonate (0.237%), | | | | | | | | | |
| | Fumaric acid (0.232%), Purified water, pH 4.3 | | | | | | | | | |
| 82 | Sucralose(25%), Sodium Benzoate (0.06%), Sodium | Clear liquid | Colourless | 25.2 | 4.56 | 24.9 | 4.36 | 24.8 | 4.3 | Complies |
| | metabisulfite (0.1%), Sodium bicarbonate (0.237%), | | | | | | | | | |
| | Fumaric acid (0.232%), Purified water, pH 4.56 | | | | | | | | | |
| 83 | Sucralose(25%), Sodium Benzoate (0.07%), Sodium | Clear liquid | Colourless | 24.9 | 4.56 | 24.7 | 4.5 | 24.85 | 4.4 | Complies |
| | metabisulfite (0.1%), Sodium bicarbonate (0.237%), | | | | | | | | | |
| | Fumaric acid (0.232%), Purified water, pH 4.56 | | | | | | | | | |
| 84 | Sucralose(25%), Sodium Benzoate (0.08%), Sodium | Clear liquid | Colourless | 25.05 | 4.47 | 24.9 | 4.39 | 24.88 | 4.4 | Complies |
| | metabisulfite (0.1%), Sodium bicarbonate (0.237%), | | | | | | | | | |
| | Fumaric acid (0.232%), Purified water, pH 4.47 | | | | | | | | | |
| 85 | Sucralose(25%), Sodium Benzoate (0.09%), Sodium | Clear liquid | Colourless | 25.12 | 4.46 | 25.2 | 4.39 | 24.88 | 4.39 | Complies |
| | metabisulfite (0.1%), Sodium bicarbonate (0.237%), | | | | | | | | | |
| | Fumaric acid (0.232%), Purified water, pH 4.46 | | | | | | | | | |
| 86 | Sucralose(25%), Sodium metabisulfite (0.25%), Sodium | Clear liquid | Colourless | 25.4 | 4.49 | 25.3 | 4.4 | 25.19 | 4.4 | Complies |
| | bicarbonate (0.237%), Fumaric acid (0.232%), Purified | | | | | | | | | |
| | water, pH 4.49 | | | | | | | | | |
| 87 | Sucralose(25%), Sodium Benzoate (0.05%), Sodium | Clear liquid | Colourless | 25.2 | 4.59 | 25.1 | 4.5 | 24.92 | 4.51 | Complies |
| | metabisulfite (0.25%), Sodium bicarbonate (0.237%), | | | | | | | | | |
| | Fumaric acid (0.232%), Purified water, pH 4.59 | | | | | | | | | |
| 88 | Sucralose(25%), Sodium Benzoate (0.06%), Potasium | Clear liquid | Colourless | 25.1 | 4.52 | 24.9 | 4.38 | 24.72 | 4.48 | Complies |
| | sorbate (0.05%), Sodium bicarbonate (0.237%), | | | | | | | | | |
| | Fumaric acid (0.232%), Purified water, pH 4.52 | | | | | | | | | |
| 89 | Sucralose(25%), Sodium Benzoate (0.08%), Potasium | Clear liquid | Colourless | 25.02 | 4.42 | 24.8 | 4.35 | 24.88 | 4.4 | Complies |
| | sorbate (0.05%), Sodium bicarbonate (0.237%), | | | | | | | | | |
| | Fumaric acid (0.232%), Purified water, pH 4.42 | | | | | | | | | |
| 90 | Sucralose(25%), Sodium Benzoate (0.05%), Potasium | Clear liquid | Colourless | 24.8 | 4.51 | 24.7 | 4.4 | 25.01 | 4.4 | Complies |
| | sorbate (0.06%), Sodium bicarbonate (0.237%), | | | | | | | | | |
| | Fumaric acid (0.232%), Purified water, pH 4.51 | | | | | | | | | |
| 91 | Sucralose(25%), Sodium Benzoate (0.05%), Potasium | Clear liquid | Colourless | 25.1 | 4.5 | 24.9 | 4.48 | 24.92 | 4.4 | Complies |
| | sorbate (0.08%), Sodium bicarbonate (0.237%), | | | | | | | | | |
| | Fumaric acid (0.232%), Purified water, pH 4.50 | | | | | | | | | |
| 92 | Sucralose(25%), Sodium Benzoate (0.05%), Sodium | Clear liquid | Colourless | 25.02 | 4.34 | 24.9 | 4.3 | 24.77 | 4.2 | Complies |
| | bicarbonate (0.237%), Fumaric acid (0.232%), Purified | | | | | | | | | |
| | water, pH 4.34 | | | | | | | | | |
| 93 | Sucralose(25%), Sodium metabisulfite (0.1%), Sodium | Clear liquid | Colourless | 25.2 | 4.4 | 25.1 | 4.2 | 24.8 | 4.2 | Complies |
| | bicarbonate (0.237%), Fumaric acid (0.232%), Purified | | | | | | | | | |
| | water, pH 4.40 | | | | | | | | | |
| 94 | Sucralose(25%), Sodium metabisulfite (0.25%), Sodium | Clear liquid | Colourless | 25.1 | 4.35 | 25.05 | 4.28 | 24.92 | 4.2 | Complies |
| | bicarbonate (0.237%), Fumaric acid (0.232%), Purified | | | | | | | | | |
| | water, pH 4.35 | | | | | | | | | |
| 95 | Sucralose(25%), Sodium metabisulfite (0.5%), Sodium | Clear liquid | Colourless | 25.4 | 4.4 | 25.3 | 4.4 | 25.02 | 4.3 | Complies |
| | bicarbonate (0.237%), Fumaric acid (0.232%), Purified | | | | | | | | | |
| | water, pH 4.40 | | | | | | | | | |
| 96 | Sucralose(25%), Sodium chloride (1.1129%), Glycine | Clear liquid | Colourless | 25.02 | 4.6 | 24.9 | 4.5 | 24.92 | 4.5 | Complies |
| | (0.2%), Purified water, pH 4.60 | | | | | | | | | |
| 97 | Sucralose(25%), Sodium Benzoate (0.05%), Sodium | Clear liquid | Colourless | 24.7 | 4.66 | 24.5 | 4.35 | 24.77 | 4.5 | Complies |
| | chloride (1.1129%), Glycine (0.2%), Purified water, pH | | | | | | | | | |
| | 4.66 | | | | | | | | | |
| 98 | Sucralose(25%), Sodium Benzoate (0.05%), Sodium | Clear liquid | Colourless | 25.4 | 4.5 | 25.3 | 4.29 | 24.83 | 4.4 | Complies |
| | Meta bisulfite(0.05%), Sodium bicarbonate (0.237%), | | | | | | | | | |
| | Fumaric acid (0.232%), Purified water, pH 4.50 | | | | | | | | | |
| 99 | Sucralose(25%), Sodium Benzoate (0.05%), Sodium | Clear liquid | Colourless | 25.7 | 4.5 | 25.8 | 4.3 | 25.27 | 4.3 | Complies |
| | Meta bisulfite(0.005%), Sodium bicarbonate (0.237%), | | | | | | | | | |
| | Fumaric acid (0.232%), Purified water, pH 4.50 | | | | | | | | | |
| 100 | Sucralose(25%), Sodium Benzoate (0.05%), Sodium | Clear liquid | Colourless | 25.1 | 4.5 | 25.04 | 4.28 | 25.03 | 4.4 | Complies |
| | Meta bisulfite(0.0015%), Sodium bicarbonate (0.237%), | | | | | | | | | |
| | Fumaric acid (0.232%), Purified water, pH 4.50 | | | | | | | | | |
| 101 | Sucralose(25%), Sodium Benzoate (0.05%), Sodium | Clear liquid | Colourless | 25.5 | 4.5 | 25.4 | 4.4 | 25.11 | 4.4 | Complies |
| | Meta bisulfite(0.001%), Sodium bicarbonate (0.237%), | | | | | | | | | |
| | Fumaric acid (0.232%), Purified water, pH 4.50 | | | | | | | | | |
| 102 | Sucralose(25%), Sodium Benzoate (0.06%), Sodium | Clear liquid | Colourless | 25.02 | 4.5 | 25.1 | 4.45 | 25.02 | 4.4 | Complies |
| | Meta bisulfite(0.05%), Sodium bicarbonate (0.237%), | | | | | | | | | |
| | Fumaric acid (0.232%), Purified water, pH 4.50 | | | | | | | | | |
| 103 | Sucralose(25%), Sodium Benzoate (0.08%), Sodium | Clear liquid | Colourless | 25.05 | 4.5 | 24.9 | 4.4 | 24.72 | 4.4 | Complies |
| | Meta bisulfite(0.05%), Sodium bicarbonate (0.237%), | | | | | | | | | |
| | Fumaric acid (0.232%), Purified water, pH 4.50 | | | | | | | | | |
| 104 | Sucralose(25%), Sodium Benzoate (0.09%), Sodium | Clear liquid | Colourless | 25 | 4.5 | 24.9 | 4.4 | 25.12 | 4.45 | Complies |
| | Meta bisulfite(0.05%), Sodium bicarbonate (0.237%), | | | | | | | | | |
| | Fumaric acid (0.232%), Purified water, pH 4.50 | | | | | | | | | |
| 105 | Sucralose(25%), Sodium Benzoate (0.06%), Sodium | Clear liquid | Colourless | 25.4 | 4.5 | 25.4 | 4.3 | 25.21 | 4.5 | Complies |
| | Meta bisulfite(0.005%), Sodium bicarbonate (0.237%), | | | | | | | | | |
| | Fumaric acid (0.232%), Purified water, pH 4.50 | | | | | | | | | |
| 106 | Sucralose(25%), Sodium Benzoate (0.05%), Sodium | Clear liquid | Colourless | 25.8 | 4.5 | 25.7 | 4.28 | 25.41 | 4.3 | Complies |
| | Meta bisulfite(0.005%), Sodium bicarbonate (0.237%), | | | | | | | | | |
| | Fumaric acid (0.232%), Purified water, pH 4.50 | | | | | | | | | |
| 107 | Sucralose(25%), Sodium Benzoate (0.08%), Sodium | Clear liquid | Colourless | 25.5 | 4.5 | 25.4 | 4.4 | 25.12 | 4.4 | Complies |
| | Meta bisulfite(0.005%), Sodium bicarbonate (0.237%), | | | | | | | | | |
| | Fumaric acid (0.232%), Purified water, pH 4.50 | | | | | | | | | |
| 108 | Sucralose(25%), Sodium Benzoate (0.09%), Sodium | Clear liquid | Colourless | 25.2 | 4.5 | 25.04 | 4.5 | 24.99 | 4.4 | Complies |
| | Meta bisulfite(0.005%), Sodium bicarbonate (0.237%), | | | | | | | | | |
| | Fumaric acid (0.232%), Purified water, pH 4.50 | | | | | | | | | |
| 109 | Sucralose(25%), Sodium Benzoate (0.05%), Sodium | Clear liquid | Colourless | 25.72 | 4.5 | 25.7 | 4.4 | 25.5 | 4.4 | Complies |
| | Meta bisulfite(0.0015%), Sodium bicarbonate (0.237%), | | | | | | | | | |
| | Fumaric acid (0.232%), Purified water, pH 4.50 | | | | | | | | | |
| 110 | Sucralose(25%), Sodium Benzoate (0.06%), Sodium | Clear liquid | Colourless | 25.1 | 4.5 | 24.9 | 4.3 | 25.03 | 4.5 | Complies |
| | Meta bisulfite(0.0015%), Sodium bicarbonate (0.237%), | | | | | | | | | |
| | Fumaric acid (0.232%), Purified water, pH 4.50 | | | | | | | | | |
| 111 | Sucralose(25%), Sodium Benzoate (0.08%), Sodium | Clear liquid | Colourless | 25.4 | 4.5 | 24.9 | 4.38 | 25.11 | 4.4 | Complies |
| | Meta bisulfite(0.0015%), Sodium bicarbonate (0.237%), | | | | | | | | | |
| | Fumaric acid (0.232%), Purified water, pH 4.50 | | | | | | | | | |
| 112 | Sucralose(25%), Sodium Benzoate (0.09%), Sodium | Clear liquid | Colourless | 25.1 | 4.5 | 24.5 | 4.4 | 24.89 | 4.3 | Complies |
| | Meta bisulfite(0.0015%), Sodium bicarbonate (0.237%), | | | | | | | | | |
| | Fumaric acid (0.232%), Purified water, pH 4.50 | | | | | | | | | |
| 113 | Sucralose(25%), Sodium Benzoate (0.05%), Sodium | Clear liquid | Colourless | 24.7 | 4.5 | 24.6 | 4.35 | 24.98 | 4.4 | Complies |
| | Meta bisulfite(0.001%), Sodium bicarbonate (0.237%), | | | | | | | | | |
| | Fumaric acid (0.232%), Purified water, pH 4.50 | | | | | | | | | |
| 114 | Sucralose(25%), Sodium Benzoate (0.06%), Sodium | Clear liquid | Colourless | 24.8 | 4.5 | 24.7 | 4.35 | 24.55 | 4.4 | Complies |
| | Meta bisulfite(0.001%), Sodium bicarbonate (0.237%), | | | | | | | | | |
| | Fumaric acid (0.232%), Purified water, pH 4.50 | | | | | | | | | |
| 115 | Sucralose(25%), Sodium Benzoate (0.08%), Sodium | Clear liquid | Colourless | 24.9 | 4.5 | 24.9 | 4.42 | 24.71 | 4.4 | Complies |
| | Meta bisulfite(0.001%), Sodium bicarbonate (0.237%), | | | | | | | | | |
| | Fumaric acid (0.232%), Purified water, pH 4.50 | | | | | | | | | |
| 116 | Sucralose(25%), Sodium Benzoate (0.09%), Sodium | Clear liquid | Colourless | 25.02 | 4.5 | 24.8 | 4.4 | 24.5 | 4.4 | Complies |
| | Meta bisulfite(0.001%), Sodium bicarbonate (0.237%), | | | | | | | | | |
| | Fumaric acid (0.232%), Purified water, pH 4.50 | | | | | | | | | |
| 117 | Sucralose(25%), Potassium chloride (1.1129%), Glycine | Clear liquid | Colourless | 24.9 | 4.66 | 24.7 | 4.38 | 24.9 | 4.5 | Complies |
| | (0.2%), Purified water, pH 4.66 | | | | | | | | | |
| 118 | Sucralose(25%), Sodium Benzoate (0.05%), Potassium | Clear liquid | Colourless | 25.1 | 4.66 | 25.1 | 4.29 | 24.83 | 4.6 | Complies |
| | chloride (1.1129%), Glycine (0.2%), Purified water, pH | | | | | | | | | |
| | 4.66 | | | | | | | | | |
| 119 | Sucralose (25%), Sodium Benzoate (0.1%), Potassium | Clear liquid | Colourless | 25.5 | 6.51 | 25.4 | 6.2 | 25.04 | 6.4 | Complies |
| | sorbate (0.1%), Fumaric acid (0.232%), Sodium | | | | | | | | | |
| | bicarbonate (0.55%), Purified water, pH 6.51 | | | | | | | | | |
| 120 | Sucralose (25%), Sodium Benzoate (0.1%), Potassium | Clear liquid | Colourless | 24.99 | 7.21 | 25.02 | 6.7 | 24.86 | 7.1 | Complies |
| | sorbate (0.1%), Fumaric acid (0.232%), Sodium | | | | | | | | | |
| | bicarbonate (0.7%), Purified water, pH 7.21 | | | | | | | | | |
| 121 | Sucralose (25%), Sodium Benzoate (0.1%), Potassium | Clear liquid | Colourless | 25.3 | 5.3 | 25.1 | 5.1 | 24.82 | 5.2 | Complies |
| | sorbate (0.1%), Fumaric acid (0.4%), Sodium | | | | | | | | | |
| | bicarbonate (0.7%), Purified water, pH 5.3 | | | | | | | | | |

[symbol]

indicates data missing or illegible when filed

The compositions were kept for Accelerated stability study at 40° C. Relative Humidity 75.0% for 6 months & for longterm stability study at 25° C. Relative Humidity 60.0% for 1 year.

The Total Aerobic Microorganism Value expressed in cfu/ml (colony forming units per milliliter) (TAMV) and Yeast and Molds count (Y&M) was not more than maximum permissible value right from beginning up to at least the end of 12 months period of storage. In general TAMV ranged from an occasional 40 in composition no. 40 to below 10 and Y&M ranged from an occasional 30 to below 10. Since these counts are far below permissible limit of 250 cfu for TAMV and 50 details of the observations are not given here.

Staphylococcus aureus, Salmonella, escherichia coli, Pseudomonas and coliform bacteria were absent through out from the beginning up to at least the end of 12 months period of storage, and are not separately given here in the table.

Since appearance and colour did not change except for compositions 31 and 32 (where initial light yellow changed to colorless but slightly slight hazy in 12 months) only one set of observations are given as applicable for observations taken at all stages of the experiment up to 12 months period. Here too, this colour was associated where sucrose content was more than 30% in the composition. In other compositions that contained less than 30% sucrose, the composition was colorless throughout.

Observations on assay of sucralose and pH and organoleptic evaluation are given in this table for initial, at 6 months in accelerated stability study and at 12 months in long term stability study since in intermediate stages, the observations ranged between these values and the changes are not appreciable.

Observations on organoleptic evaluation are given only for 12 months observations since they were same from initial up to the 12 month observations. Compositions 1 to 14, 16.30, 41 and 43 had acidic taste and odour. All of them has Sodium Metabisulphite in a concentration higher than 2%. Rest of the compositions complied with the organoleptic evaluation with the standard sucrose taste.

Recrystallization was seen in all combinations in which sucralose dissolved was more than 25%, for example composition numbers 41, 45, 46, 50, 50b, 51, 65 to 76. However, this did not involve significant quantity of sucrlose because assay of sucralose in all these instances is close to 100% within limits of experimental error of the assay. A hazy (composition numbers 29, 29b and 30, slight hazy (39, 40, 43, 44, 46b, 47 and 48) or very slight hazy (45, 46) appearance was noted right from beginning and remained so at least up to 12 months of storage. All these compositions except two contained a hydrocolloid or a polymer such as pectin, fructo-oligosaccharide, Sodium akginate, Xanthan gum, modified starch, PVP. In composition 48, it was Sodium Potassium Tartrate and in composition 45 it was Calcium Propionate that could be responsible for hazymess. All compositions in which sucralose dissolved was 25% or less, the compositions remained clear without any crystallization from beginning up to at least 12 months of storage.

It was a surprising observation that the pH remained practically stable right from beginning up to at least 12 months of storage in all composition whether they did or did not contain a buffer.

Assay of sucralose was 100% on an average within the range of experimental error.

Composition number 78 in particular and from 89-92 in general confirmed to all the tested parameters on pilot scale production at least 5 times.

1. An un-sterilized composition of liquid sucralose concentrate sweetener that comprises at least sucralose as major sweetening ingredient in an amount of from 3 to 35% by weight of the total composition and water in an amount at least about 25%; the said composition further comprising at least one stabilizing additive which in presence of the said liquid in the said concentrate sweetener shall have a pH of about 2.5 to 7.5; the said stabilizing additive not comprising any of the following combinations of preservatives or stabilizers or sweeteners:
a. a preservative system selected from the group consisting of potassium sorbate, sodium benzoate, potassium benzoate, methyl gallate, propyl gallate, ethylenediaminetetraacetate, methyl paraben, propyl paraben and mixtures thereof, and (b) a buffering system selected from the group consisting of citric acid and sodium citrate, citric acid and potassium citrate, phosphoric acid and sodium phosphate, phosphoric acid and potassium phosphate, arginine and arginine HCl, lysine and lysine HCl, tartaric acid and sodium tartrate, tartaric acid and potassium tartrate, adipic acid and sodium adipate, adipic acid and potassium adipate, malic acid and sodium malate, malic acid and potassium malate, and sodium phosphate monobasic and sodium phosphate dibasic,
b. only an acid without buffer,
c. a preservative, an acid in absence of a buffering system, and a solvent,
d. a group of a second sweetener selected from the group consisting of a Luo Han Guo extract, a polyol, and a mixture thereof; a preservative; and an acid,
e. a preservative; and succinic acid,
f. two acids and a mixture thereof, or
g. at least one preservative, a rebaudioside A composition and a polyol.

2. A process of preparing an un-sterilized composition of liquid sucralose concentrate sweetener of claim 1 that contains sucralose as major solid ingredient of comprising steps of:
a. heating a required quantity of purified water to about 40° C. or about 60 degrees,
b. adding required quantity of sucralose with stirring, cooling to about 40 degrees if heated up to 60 degrees,
c. optionally treating with activated charcoal followed by filtration,
d. maintaining the temperature at 40-55° C. during mixing, cooling and filtering through 80 mesh filter,
e. adding at least one stabilizing ingredient followed sequentially by other ingredient/s if any
f. adjusting the pH, if necessary,
g. making to final volume by the said liquid.

3. The un-sterilized composition of liquid sucralose concentrate sweetener of claim 1, with or without a mixed buffer with acid component being a first edible acid and the base component being a salt of second acid with dissociation constant different than the first acid to cover a range of pH from 4 to 6.5, wherein the said stabilizing additive comprises at least of one of the following groups:
a. a polymer stabilizer or a hydrocollide stabilizer, or
b. at least one osmoticum added to saturate water available for microbial growth in the composition and thereby check microbial growth, the said water being added as an ingredient or the moisture that may enter from the ambient in the composition in course of reuse, and the said osmoticum being an ingredient that is soluble in water and generates an osmotic pressure in solution or
c. a preservative,
d. an antibiotic permitted in food, or
e. a combination thereof.

4. The un-sterilized composition of liquid sucralose concentrate sweetener of claim 2 wherein,
a. the said first acid for the said mixed buffer is selected from fumaric acid, succinic acid, lactic acid, glutamic acid, glycine, gluconic acid, acetic acid (including di acetic acid), adipic acid, aspartic acid, citric acid, gluconic acid (glucono delta lactone), glutamic acid, lactic acid, malic acid, phosphoric acids (ortho, di and poly phosphoric acid), succinic acid, tartaric acid or a mixture thereof; and the said base of second acid selected, after omitting the salt of the said first selected acid, from the group sodium bicarbonate, dibasic sodium phosphates, sodium polyphosphates, sodium potassium tartarate, and other such salts selected from following: ammonium acetate, calcium acetate, potassium acetate, sodium acetate, ammonium adipate, potassium adipate, sodium adipate, potassium aspartate (mono and dibasic), sodium aspartate (mono and dibasic), ammonium bicarbonate, calcium bicarbonate, magnesium bicarbonate, potassium bicarbonate, sodium bicarbonate, potassium citrate (mono, di and tribasic), sodium citrate (mono, di and tribasic), potassium fumarate (mono and di), sodium fumarate (mono and di), calcium gluconate, potassium gluconate, sodium gluconate, potassium glutamate (mono and di), sodium glutamate mono and di), ammonium lactate, calcium lactate, magnesium lactate, potassium lactate, sodium lactate, calcium malate (mono and di), potassium malate (mono and di), sodium malate (mono and di), ammonium salts of phosphoric acids (mono and di basic salts), calcium salts of phosphoric acids (mono and di basic salts), magnesium salts of phosphoric acids (mono and di basic salts), potassium salts of phosphoric acids (mono and di basic salts), sodium salts of phosphoric acids (mono and di basic salts), sodium succinate (mono and dibasic), potassium succinate (mono and dibasic), sodium tartarate (mono and di basic), potassium tartarate (mono and di basic), sodium potassium tartarate, sodium aluminium phosphate (acidic), sodium aluminium phosphate (basic), or a combinations thereof,
b. the said polymer stabilizer comprising at least Pectin, Sodium alginate, xanthan gum, or modified starch or a combination thereof,
c. the said osmoticum comprising any one of Sodium chloride, Potassium chloride, glucose, sucrose, corn syrup and invert sugar, or a combination thereof,
d. the said preservative comprises any one of potassium sorbate, sodium benzoate, potassium benzoate, methyl gallate, propyl gallate, ethylenediaminetetraacetate, methyl paraben, propyl paraben, Acetic Acid, Sodium Acetate, Potassium Acetate, Sodium Diacetate, Potassium Diacetate, Sodium Metabisulphite, Potassium Metabisulphite, Calcium Hydrogen sulphite, Sodium Bisulphite, Potassium Bisulphite, Benzoic acid, Potassium Benzoate, Calcium Benzoate, Sodium Benzoate, Propionic acid, Potassium Propionate, Calcium Propionate, Sodium Propionate, Sorbic Acid, Potassium Sorbate, Calcium Sorbate, Sodium Sorbate, Ethylene Diamine Tetra Acetate, Calcium Ethylene Diamine Tetra Acetate, Sodium Ethylene Diamine Tetra Acetate, Ethyl Paraben, Methyl Paraben, SO₂, sodium metabysulphite or mixtures thereof,
e. the said antibiotic is Nisin.

5. The un-sterilized composition of liquid sucralose concentrate sweetener of claim 1 wherein the said liquid is one or more of water, ethyl alcohol, polyethylene glycol, polysorbate, glycerol or a mixture thereof.

6. The un-sterilized composition of liquid sucralose concentrate sweetener, of claim 5 wherein:
a. the said liquid constitutes about 97% to 25% of the said composition, and
b. the pH ranges between 2.5 to 7.5.

7. The un-sterilized sweetener composition of claim 2 wherein the compound buffering system is present in an amount from 0.2% to 5% by weight of the total composition.

8. The un-sterilized sweetener composition of claim 2 wherein the compound buffering system is present in an amount from 0.5% to 2% by weight of the total composition.

9. The un-sterilized sweetener composition of claim 2 comprising at least Sucralose, Sodium Benzoate, Potassium sorbate, Fumaric acid, Sodium bicarbonate as ingredients dissolved in water.

10. The un-sterilized sweetener composition of claim 9 that is adjusted to pH 4.5.
